(19) United States
(12) Patent Application Publication
(10) Pub. No.: US 2017/0155596 A1
(43) Pub. Date: Jun. 1, 2017

(54) Method And Electronic Device For Bandwidth Allocation

(71) Applicants: Le Holdings (Beijing) Co., Ltd., Beijing (CN); LeCloud Computing Co., Ltd., Beijing (CN)

(72) Inventors: Zongrui Jin, Beijing (CN); Junwei Wu, Beijing (CN); Junshi Liu, Beijing (CN)

(21) Appl. No.: 15/253,164

(22) Filed: Aug. 31, 2016

Related U.S. Application Data
(63) Continuation of application No. PCT/CN2016/083197, filed on May 24, 2016.

(30) Foreign Application Priority Data
Nov. 26, 2015 (CN) 201510845478.9

(51) Int. Cl. H04L 12/911; H04L 12/927

(52) U.S. Cl. CPC H04L 47/781; H04L 47/805

(57) ABSTRACT

Disclosed is a method and electronic device for bandwidth allocation. The method includes, at an electronic device: receiving a service access request from a user; parsing the request to determine the user's service attribute which at least includes a requested bandwidth, a currently occupied bandwidth and a priority; and determining a strategy for bandwidth allocation, including: determining a predetermined available bandwidth for the determined priority, comparing a sum of the requested bandwidth and currently occupied bandwidth with the available bandwidth, and refusing to allocate the requested bandwidth if the sum of the requested bandwidth and currently occupied bandwidth is greater than the available bandwidth, or otherwise allocating the requested bandwidth. The embodiments of the disclosure show the method and electronic device for bandwidth allocation in question, which allocate user's bandwidth in a dynamic manner, realize efficient utilization thereof and avoid wastes therefrom.

### CROSS REFERENCE TO RELATED APPLICATIONS

This application is a continuation of International Application No. PCT/CN2016/083197, filed on 24 May 2016, which is based upon and claims priority to Chinese Patent Application No. 201510845478.9, filed on 26 Nov. 2015, the entire contents of which are incorporated herein by reference.

### TECHNICAL FIELD

This disclosure relates to internet technology, particularly to a method and electronic device for bandwidth allocation.

### BACKGROUND

Currently, technical architecture of most video websites is based on CDN, along with some P2P technologies. CDN is an abbreviation of content delivery network, i.e. content allocation network. When a user clicks a video on the website, the video website would work with CDN to provide a server which could best serve the user based on his/her geographic location and network conditions. Simply speaking, data is like the actual goods which are packed and transported to a destination via logistics as necessary. CDN plays such a role as logistics in data transportation.

More video playing on the website would require more CDN and the need for bandwidth would be higher as well. Audiences of video websites and the bandwidth required increase simultaneously, i.e. if the audiences increase by 100 times, so do the bandwidth costs.

Traditional mode of bandwidth provision for video website is to provide a fixed bandwidth which is larger than the previous peak bandwidth of the website. Although such mode seems to have satisfied the maximum need of the user (i.e. the video website) to the fullest extent, the actual use of such bandwidth seldom reach its peak, which would cause waste of such over-distributed bandwidth. Since bandwidth is limited (and there's unused bandwidth), such mode would certainly affect the normal service provided to other users.

### SUMMARY

The disclosure provides a method and electronic device for bandwidth allocation so as to solve the waste of bandwidth resource caused by fixed allocation of bandwidth to users in the prior art which cannot utilize bandwidth efficiently.

According to an aspect of the disclosure, a method for bandwidth allocation is provided, which includes, at an electronic device:

receiving a service access request from a user;

parsing the access request to determine the user's service attribute which at least includes a requested bandwidth, a currently occupied bandwidth and a priority; and

determining a strategy for bandwidth allocation, including:

determining a predetermined maximum available bandwidth for the determined priority; and

comparing a sum of the requested bandwidth and currently occupied bandwidth with the maximum available bandwidth, and refusing to allocate the requested bandwidth if the sum of the requested bandwidth and currently occupied bandwidth is greater than the maximum available bandwidth, or otherwise allocating the requested bandwidth.

According to another aspect of the disclosure, an electronic device for bandwidth allocation is provided, including: at least one processor; and a memory communicably connected with the at least one processor for storing instructions executable by the at least one processor, wherein execution of the instructions by the at least one processor causes the at least one processor to execute the method for bandwidth allocation mentioned above.

According to yet another aspect of the disclosure, provided is a non-transitory computer-readable storage medium storing executable instructions that, when executed by an electronic device, cause the electronic device to execute the method for bandwidth allocation mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for bandwidth allocation according to an embodiment of the disclosure;

FIG. 2 is a flow chart of a method for bandwidth allocation according to another embodiment of the disclosure;

FIG. 3 is a schematic view of a system for bandwidth allocation according to an embodiment of the disclosure;

FIG. 4 is a schematic view of a system for bandwidth allocation according to another embodiment of the disclosure;

FIG. 5 is a frame structural diagram for implementing a system for bandwidth allocation according to the disclosure; and

FIG. 6 is a structural schematic diagram of an electronic device or a server according to an embodiment of the disclosure.

### DETAILED DESCRIPTION

In order to make the purpose, technical solutions, and advantages of the embodiments of the disclosure more clearly, technical solutions of the embodiments of the disclosure will be described clearly and completely in conjunction with the figures. Obviously, the described embodiments are merely part of the embodiments of the disclosure, but not all embodiments. Based on the embodiments of the disclosure, other embodiments obtained by the ordinary skill in the art without inventive efforts are within the scope of the disclosure.

It should be noted that, embodiments of the present application and the technical features involved therein may be combined with each other in case they are not conflict with each other.

The disclosure is applicable to various general-purpose and specific-purpose computer system environments or configurations, such as a personal computer, a server computer, a handheld device or portable device, a tablet device, a multi-processor system, a microprocessor-based system, a set-top box, a programmable consumer electronic device, a network PC, a mini-computer, a mainframe computer, a distributed computing environment including any of the above-listed systems or devices.

The disclosure can be described in a general context where a computer executes computer-executable instructions, such as program modules. Typically, program modules include routines, programs, objects, components, data structures, etc. which perform certain tasks or implement certain abstract data types. The disclosure can also be implemented in a distributed computing environment, where tasks are performed by a remote processing device connected through a communication network. In a distributed computing environment, program modules may be stored in storage mediums including memory device of the local and remote computer.

Finally, it should also be noted that, wordings like first and second are merely for separating one entity or operation from the other, but not intended to require or imply a relation or sequence among these entities or operations. Further, terms like “include”, “comprise”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

As shown in FIG. 1, a method for bandwidth allocation according to an embodiment of the disclosure includes:

S11, the server receives a service access request from a user;

S12, the server parses the access request to determine the user's service attribute which at least includes a requested bandwidth, a currently occupied bandwidth and a priority, etc.;

S13, the server determines a predetermined maximum available bandwidth for the priority;

S14, the server compares a sum of the requested bandwidth and currently occupied bandwidth with the maximum available bandwidth; and

S15, when the sum of the requested bandwidth and currently occupied bandwidth is greater than maximum available bandwidth, the server refuses to allocate the requested bandwidth; and if the sum of the requested bandwidth and currently occupied bandwidth is smaller than the maximum available bandwidth, the server allocates the requested bandwidth.

In this embodiment, the server divides requests into different priorities according to users' service needs. Here, taking two priorities as example, the first priority and the second priority (though two levels are given as an example, the priority is not limited to two levels as more levels can be set according to needs), to provide personalized bandwidth allocation and meet the different needs of users. In addition, in this embodiment, bandwidth allocation is based on the user's priority as well as its currently occupied bandwidth (that is, allocating bandwidth for the user is based on the service needs of users and their current situation of bandwidth usage), thus an effective use of bandwidth is realized, and the waste of bandwidth resources is avoided.

After the server receives the user's access request, it shall determine the identity of the user sending access request messages, and then determine the user's priority based on the priority information of the user.

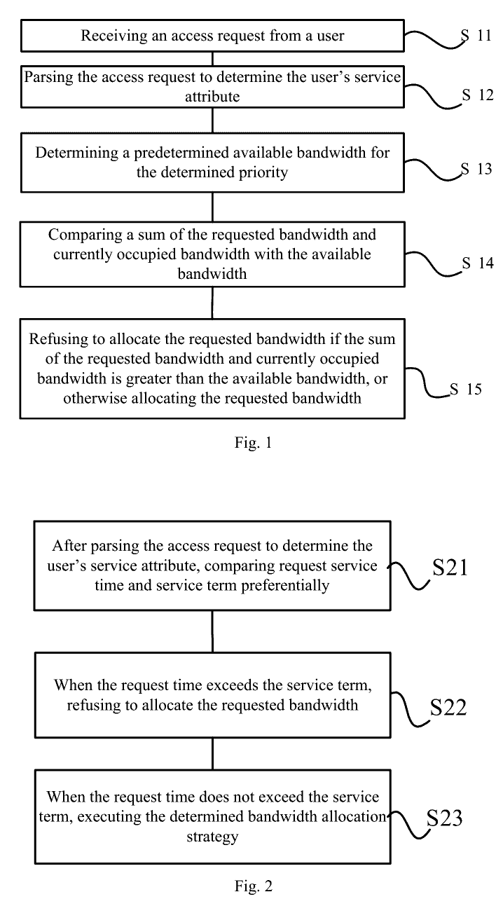

As shown in FIG. 2, in some embodiments, the user's service attribute also includes request time and service term, and the method includes the following steps.

In S21, after the server parses the access request to determine the user's service attribute, the request time and the service term are compared preferentially.

In S22, when the request time exceeds the service term, the server refuses to allocate the requested bandwidth;

In S23, when the request time does not exceed the service term, the bandwidth allocation strategy is implemented.

In the embodiment, through setting the validity of priority for the user, the utilization of bandwidth resources will be improved elaborately. Validity period can be calculated in accordance with quarter, month, day, hour or even minute, or it can be calculated according to a certain period of a day. In this way, the first priority service can be provided for a user according to the peak of the user's business. In the period other than the peak, other priority service can be provided so as to realize more rational utilization of bandwidth to avoid waste due to excessive assignment of bandwidth resources to the user outside the peak period.

In some embodiments, after the users complete the business access with the allocated bandwidth as requested, the server will recycle requested bandwidth to update the user's currently occupied bandwidth.

In the embodiments, real-time detection is made to detect whether the user's access request has been completed, and when it is completed, the bandwidth occupied by user's access request is recycled and re-allocated to the user for a new access request or any other user's access request so as to avoid idle bandwidth resources, thus improving the bandwidth resource utilization.

In some embodiments, the server determines the priority at least according to the comparison of the period within which the access request issues with the pre-set time period/priority model.

In some embodiments, users have different priority in different periods according to the user's portfolio allocation in different times. Because users provide different amount of business services in each period, higher priority for service access can be allocated at the peak hour and lower priority for service access can be allocated at the low peak hour.

Accordingly, in some embodiments, determining the user's service properties includes determining the user's current priority according to the period of request time of the user's access request. When specific server receives the access request, the source of the access request (i.e., the identity of the user) and the current time (namely request time) are determined first, and then the pre-set period/priority model corresponding to the user (for example, priority allocation list) are called. Different priorities of the user in different periods are stored in period/priority model. The server determines the user's priority according to the decided request time and period/priority model.

In the embodiment, through setting the validity period of priority for the user by assigning different priorities to the user in different period, the utilization of bandwidth resources will be improved more elaborately. Validity period can be counted in accordance with quarter, month, day, hour or minute, or can be counted according to a certain period of a day. In this way, the first priority service can be provided for a user at the peak of the user's business. In the period other than the peak, other priority service can be provided so as to realize more rational utilization of bandwidth to avoid waste due to excessive assignment of bandwidth resources to the user outside the peak period. In addition considering that the limit bandwidth resource, in this embodiment, a pre-set bandwidth limit is set for the second priority of each user, so as to realize more reasonable allocation of bandwidth resources.

In the above embodiments, priority at least includes a first priority and a second priority, wherein bandwidth of the first priority users is unlimited, and the bandwidth of second priority users does not exceed the upper limit of pre-set bandwidth (that is, the maximum available bandwidth).

Second priority includes many sub-priorities, and accordingly the pre-set bandwidth upper limit (that is, the maximum available bandwidth) includes many pre-set sub-bandwidth upper limit (that is, the maximum available sub-bandwidth). Sub-bandwidth priority and sub-pre-set bandwidth upper limit are one-to-one correspondence. The available bandwidth corresponding to a sub-priority of each user does not exceed the corresponding preset sub-bandwidth upper limit. In the embodiment, the second priority is divided into a plurality of sub-priorities, and a corresponding preset sub-bandwidth upper limit is set therefor, thus providing a more refined method for bandwidth allocation. The corresponding bandwidth resources is provided according to the amount of different users and quality of service for a user is guaranteed. Meanwhile, under the condition of the limited bandwidth resources, such a situation that excessive bandwidth resource is allocated for a particular user and meanwhile other users cannot share the bandwidth, which impacts on the quality of service to the other users, can also avoided, thus a more reasonable allocation of bandwidth resources is realized. In addition, each user can have different priority in different period (first priority and second priority), combined with the validity period of the above embodiments, the users can be provided with different priority according to the amount of services in each period (e.g. a higher priority for service access can be allocated at the peak hour and a lower priority for service access can be allocated at the low peak hour).

In the embodiments of the disclosure, the relevant functions can be realized through hardware processor.

It is necessary to explain that for simple descriptions of the cases for the aforementioned example a series of merged actions is used, but technicians in the field should be aware that the disclosure is not limited by the described action sequence, because according to the disclosure, some steps can be used in other order or simultaneously. Secondly, technicians in the field should be aware that the described examples of the instructions are preferred embodiment example, involved actions and modules are not necessarily required by the disclosure.

In the embodiments above, each embodiment is given different stress in descriptions. Those parts without detailed description in an embodiment can be referred to in other embodiments for relevant description.

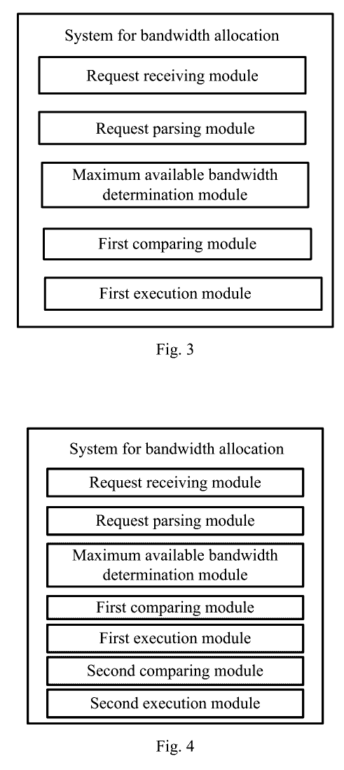

As shown in FIG. 3, on the other hand, the disclosure also provides a system for bandwidth allocation, which includes:

a request receiving module for receiving a service access request from a user;

a request parsing module for parsing the service access request received by the request receiving module to determine the user's service attribute which at least includes a requested bandwidth, a currently occupied bandwidth and a priority;

a maximum available bandwidth determining module for determining a predetermined maximum available bandwidth for the priority determined by the request parsing module;

a first comparing module for comparing a sum of the currently occupied bandwidth and the requested bandwidth determined by the request parsing module with the maximum available bandwidth determined by the maximum available bandwidth determining module; and

a first execution module for refusing to allocate the requested bandwidth if the first comparing module determines that the sum of the requested bandwidth and currently occupied bandwidth is greater than the maximum available bandwidth, or permitting the allocating of the requested bandwidth if the first comparing module determines that the sum of the requested bandwidth and currently occupied bandwidth is smaller than the maximum available bandwidth.

In this embodiment, the request parsing module can parse the access request and determine the occupied bandwidth and the current priority. The priority is divided into a first priority and a second priority according to the needs of the user's service (here, taking two levels as example, but it is not limited to two levels as more levels can be set according to the needs), to provide personalized bandwidth allocation and meet the different needs of users. In addition, the first execution module in the embodiment allocates bandwidth based on the user's priority as well as its currently occupied bandwidth (that is, allocating bandwidth for the user by combining with the service needs of the users and their currently occupied bandwidth usage situation). Thus, an effective use of bandwidth is realized, and the waste of bandwidth resources is avoided.

In this embodiment, the system for bandwidth allocation is a server or server cluster, each module can be a single server or server cluster. As such, interactions of the above modules are interactions among the corresponding server or server cluster, and multiple servers or server cluster together constitute the system for bandwidth allocation of the disclosure.

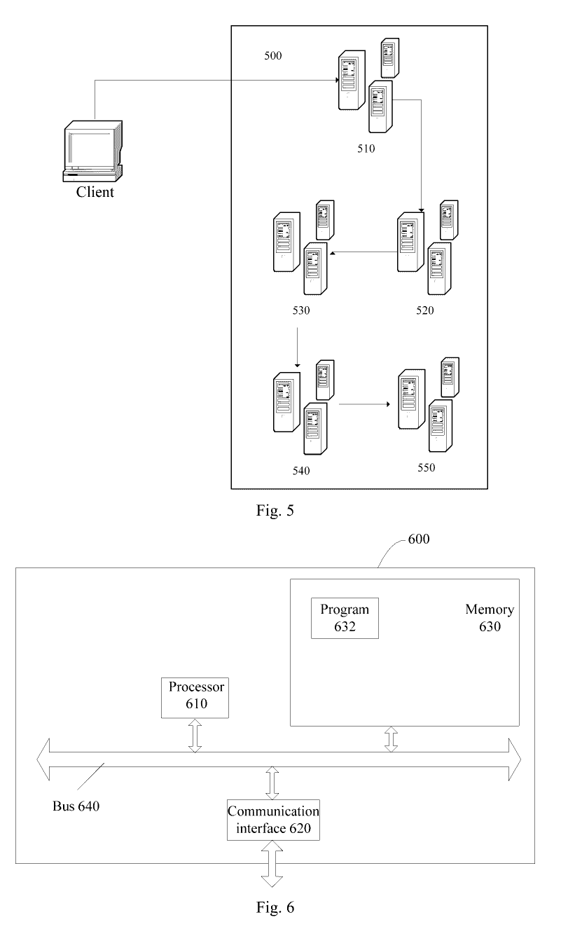

As shown in FIG. 5, specifically, a system for bandwidth allocation 500 of the example includes:

a request receiving server or server cluster 510 for receiving a service access request from a user;

a request parsing server or server cluster 520 for parsing the service access request received by the request receiving module to determine the user's service attribute which at least includes a requested bandwidth, a currently occupied bandwidth and a priority;

a maximum available bandwidth determining server or server cluster 530 for determining a predetermined maximum available bandwidth for the priority determined by the request parsing module;

a first comparing server or server cluster 540 for comparing a sum of the currently occupied bandwidth and the requested bandwidth determined by the request parsing module with the maximum available bandwidth determined by the maximum available bandwidth determining module.

a first execution server or server cluster 550 for refusing to allocate the requested bandwidth if the first comparing module determines that the sum of the requested bandwidth and currently occupied bandwidth is greater than the maximum available bandwidth, or permitting the allocating of the requested bandwidth if the first comparing module determines that the sum of the requested bandwidth and currently occupied bandwidth is smaller than the maximum available bandwidth.

In an alternative embodiment, several modules of the above modules can form a server or server cluster. For example, the request receiving module and the request parsing module form the first server or the first server cluster, the maximum available bandwidth determine modules constitute the second server or the second server cluster, the first comparing module and the first execution module constitute the third server or the third server cluster.

At this point, the interaction of the above modules is shown as the interaction between the first server and the third server or the interaction between the first server cluster and the third server cluster. The first server and the third server or the first server cluster and the third server cluster jointly constitute the system for bandwidth allocation of the disclosure.

As shown in FIG. 4, in some embodiments, a second module and a second execution module are also included.

The user's service attribute further includes request time and service term.

The second comparing module is configured to compare the request time and the service term preferentially after parsing the access request to determine the user's service attribute.

The second execution module is configured to, when the request time exceeds the service term, refuse to allocate the requested bandwidth; and when the request time does not exceed the service term, implement the bandwidth allocation strategy.

In this embodiment, through setting the validity of priority for the user, the utilization of bandwidth resources will be improved elaborately. Validity period can be calculated in accordance with quarter, month, day, hour or even minute, or it can be calculated according to a certain period of a day. In this way, the first priority service can be provided for a user according to the peak of the user's business. In the period other than the peak, other priority service can be provided so as to realize more rational utilization of bandwidth to avoid waste due to excessive assignment of bandwidth resources to the user outside the peak period.

In this embodiment, the second comparing module and the second execution module are respectively a server or server cluster, and interactions between the above modules are interactions between the servers or server cluster corresponding to the modules.

In some alternative embodiments, the second comparing module and the second execution module jointly constitute a server or server cluster.

In other alternative embodiments, the first comparing module and the second comparing module jointly constitute a server or server cluster; the first execution module and the second execution module jointly constitute a server or server cluster.

In some embodiments, a requested bandwidth recycling module is also included for recycling the requested bandwidth after a user completes the service access through the allocated bandwidth request.

In this embodiment, the requested bandwidth recycling module is a server or server cluster.

In some alternative embodiment examples, the requested bandwidth recycling module and the first execution module jointly constitute a server or server cluster, or the requested bandwidth recycling module and the second execution module jointly constitute a server or server cluster, or the requested bandwidth recycling module, the first execution module and the first execution module jointly constitute a server or server cluster.

In this embodiment, a real-time detection shall be done to detect whether the user's access request has been completed. When it is completed, the bandwidth occupied by the user's access request is recycled and reallocated to the user for a new access request or to any other user's access request so as to avoid the idle bandwidth resources and improve the utilization bandwidth resources.

In some embodiments, a priority determining module is also included, which is configured to determine the priority of users by comparing the request period of the access request with the preset period/priority model. The period/priority model refers to establishing of the corresponding relation of the period and priority.

In this embodiment, the priority determining module is a server or server cluster.

In some alternative embodiments, the priority determining module and request parsing module jointly constitute a server or server cluster.

The method and system for bandwidth allocation in the embodiments of the disclosure assigns users with different priorities in accordance with their service request so as to provide customized bandwidth allocation for satisfying users' various needs. In addition, since the embodiments are based on the user's priority and their currently occupied bandwidth (i.e. the bandwidth is allocated in a dynamic manner based on user's access need and current usage of bandwidth), the bandwidth can thus be effectively utilized and waste of such resource can be avoided.

An embodiment of the present application provides a non-transitory computer-readable storage medium storing executable instructions that, when executed by an electronic device, cause the electronic device to execute the method for bandwidth allocation mentioned above.

FIG. 6 shows a structural schematic diagram of an electronic device or a server 600 for implementing the method for bandwidth allocation according to an embodiment of the disclosure, whilst the embodiment of the present application does not limit the specific implementation of the server 600. As shown in FIG. 6, the server 600 may include a processor 610, a communication interface 620, a memory 630, and a communication bus 640.

The processor 610, the communication interface 620, and memory 630 communicate with each other via the communication bus 640.

Communication interface 620 communicates with the network elements such as client ends.

Processor 610 executes program 632, and specifically, execute the related steps as described in the above method embodiment.

Specifically, program 632 may include program code, and the program code includes computer operation instructions.

Processor 610 may be a central processing unit CPU, or Application Specific Integrated Circuit ASIC, or is configured to one or more integrated circuits for implementing the present embodiment of the application.

The server in the above-described embodiment includes:

a memory storing computer operation instructions; and

a processor executing the computer operation instructions stored in the memory to:

receive a service assess request from a user;

parse the access request to determine the user's service attribute which at least includes a requested bandwidth, a currently occupied bandwidth and a priority; and

determine a bandwidth allocation strategy, including:

determining a predetermined available bandwidth corresponding to the determined priority;

comparing whether a sum of requested bandwidth and currently occupied bandwidth is greater than an available bandwidth, and refusing to allocate the requested bandwidth if yes, or otherwise allocate the requested bandwidth.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

It would be appreciated by the skilled in the art that, the embodiments of the disclosure can be provided as method, system, or computer program product. Therefore, the disclosure can be implemented in various ways, such as purely by hardware, or purely by software, or a combination of software and hardware. Moreover, the disclosure can be implemented as a computer program product including one or more computer executable program codes which are stored on a computer readable memory medium (including but not limited to a disk storage or optic memory, etc.).

The disclosure is described in reference to method, device (or system), and flow chart and/or block diagram of computer program product of embodiment of the disclosure. It should be understood that each flow and/or block and a combination thereof in a flow chart and/or block diagram can be implemented by computer program instruction. These computer program instruction can be provided to a universal computer, a dedicated computer, an embedded processor or a processor of other programmable data processing device to generate a machine, so that a device capable of realizing functions designated by one or more flows of a flow chart and/or one or more blocks of a block diagram can be generated through execution of instructions by a computer or processor of other programmable data processing device.

These computer program instructions may be stored in a computer readable memory which can guide the computer or other programmable data processing device to operate in a special way, so that the instruction stored in the computer readable memory generates a product including an instruction device which carries out functions designated by one or more flows of a flow chart and/or one or more blocks of a block diagram. These computer program instructions can also be loaded on a computer or other programmable data processing device so as to enable a series of operations to be carried out on the computer or other programmable device to realize processing of the computer, thus providing operations for achieving functions designated by one or more flows of a flow chart and/or one or more blocks of a block diagram by the instructions executed by the computer or other programmable device.

Finally, it should be noted that, the above embodiments are merely provided for describing the technical solutions of the disclosure, but not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for bandwidth allocation comprising, at an electronic device:
receiving a service access request from a user;
parsing the access request to determine the user's service attribute which at least comprises a requested bandwidth, a currently occupied bandwidth and a priority; and
determining a strategy for bandwidth allocation, comprising:
determining a predetermined available bandwidth according to the determined priority; and
comparing a sum of the requested bandwidth and currently occupied bandwidth with the available bandwidth, and refusing to allocate the requested bandwidth if the sum of the requested bandwidth and currently occupied bandwidth is greater than the available bandwidth, or otherwise allocating the requested bandwidth.

2. The method for bandwidth allocation as claimed in claim 1, wherein the user's service attribute further comprises request time and service term, said method further comprises:
comparing the request time and service term after parsing the access request to determine the user's service attribute;
refusing to allocate the requested bandwidth when the request time exceeds the service term; and
executing the determined bandwidth allocation strategy when the request time is within the service term.

3. The method for bandwidth allocation as claimed in claim 1, wherein after the user completes service access using the allocated requested bandwidth, the requested bandwidth is recycled to update the currently occupied bandwidth of the user.

4. The method for bandwidth allocation as claimed in claim 1, wherein the priority is determined at least based on the comparison of the time period to which the request time of the access request belongs and a preset time period/priority model.

5. An electronic device for bandwidth allocation, comprising at least one processor, and a memory communicably connected with the at least one processor for storing instructions executable by the at least one processor, wherein execution of the instructions by the at least one processor causes the at least one processor to:
receive a service access request from a user;
parse the access request to determine the user's service attribute which at least comprises a requested bandwidth, a currently occupied bandwidth and a priority;
determine a predetermined available bandwidth for the priority;
determine whether a sum of the requested bandwidth and currently occupied bandwidth is greater than the available bandwidth; and
refuse to allocate the requested bandwidth if the sum of the requested bandwidth and currently occupied bandwidth is greater than the available bandwidth, or permit the allocating of the requested bandwidth if the sum of the requested bandwidth and currently occupied bandwidth is smaller than the available bandwidth.

6. The electronic device for bandwidth allocation as claimed in claim 5, wherein the user's service attribute further comprises request time and service term;
and wherein execution of the instructions by the at least one processor further causes the at least one processor to:
compare the request time with the service term after parsing the access request to determine the user's service attribute; and
refuse to allocate the requested bandwidth when the request time exceeds the service term; and permit to allocate the requested bandwidth when the request time is within the service term.

7. The electronic device for bandwidth allocation as claimed in claim 5, wherein execution of the instructions by the at least one processor further causes the at least one processor to recycle the requested bandwidth after the user completes the service access using the allocated requested bandwidth.

8. The electronic device for bandwidth allocation as claimed in claim 5, wherein execution of the instructions by the at least one processor further causes the at least one processor to determine the priority based on the comparison of the time period to which the request time of the access request belongs and a preset time period/priority model.

9. A non-transitory computer-readable storage medium storing executable instructions that, when executed by an electronic device, cause the electronic device to:
receive a service access request from a user;
parse the access request to determine the user's service attribute which at least comprises a requested bandwidth, a currently occupied bandwidth and a priority;
determine a predetermined available bandwidth for the priority;
determine whether a sum of the requested bandwidth and currently occupied bandwidth is greater than the available bandwidth; and
refuse to allocate the requested bandwidth if the sum of the requested bandwidth and currently occupied bandwidth is greater than the available bandwidth, or permit the allocating of the requested bandwidth if the sum of the requested bandwidth and currently occupied bandwidth is smaller than the available bandwidth.

10. The non-transitory computer-readable storage medium as claimed in claim 9, wherein the user's service attribute further comprises request time and service term;
and wherein execution of the instructions by the electronic device further causes the electronic device to:
compare the request time with the service term after parsing the access request to determine the user's service attribute; and
refuse to allocate the requested bandwidth when the request time exceeds the service term; and permit to allocate the requested bandwidth when the request time is within the service term.

11. The non-transitory computer-readable storage medium as claimed in claim 9, wherein execution of the instructions by the electronic device further causes the electronic device to recycle the requested bandwidth after the user completes the service access using the allocated requested bandwidth.

12. The non-transitory computer-readable storage medium as claimed in claim 9, wherein execution of the instructions by the electronic device further causes the electronic device to determine the priority based on the comparison of the time period to which the request time of the access request belongs and a preset time period/priority model.
